(19) United States
(12) Patent Application Publication
(10) Pub. No.: US 2014/0200047 A1
(43) Pub. Date: Jul. 17, 2014

(54) Interface Card with Multiple Subscriber Identity Modules

(71) Applicant: Kuo-Liang Chen, Hsinchu City (TW)

(72) Inventor: Kuo-Liang Chen, Hsinchu City (TW)

(21) Appl. No.: 13/739,163

(22) Filed: Jan. 11, 2013

(51) Int. Cl. H04B 1/38

(52) U.S. Cl. CPC H04B 1/3816
USPC 455/558

(57) ABSTRACT

An interface card includes a circuit board having an interface unit, a communication operation processing unit mounted on the circuit board, a SIM card slot mounted on the circuit board, and a M2M SIM mounted on the circuit board. The interface unit is coupled with an interface card slot of an external electronic equipment. The SIM card slot outputs at least one signal to the communication operation processing unit. The M2M SIM is provided with a communication protocol of a predetermined telecommunication operator and outputs at least one signal to the communication operation processing unit. Thus, the interface card has a SIM card slot and a M2M SIM to provide two wireless communication connection modes for selection of a user, so that the user can select any one of the wireless communication connection modes according the practical requirement.

### BACKGROUND OF THE INVENTION

1. Field of the Invention The present invention relates to a card and, more particularly, to an interface card for a wireless communication.

2. Description of the Related Art

A conventional electronic equipment, such as a cell phone, notebook computer, i-pad or other wireless communication device, comprises a subscriber identity module (SIM) card. Thus, the information in the SIM card is connected with a telecommunication operator is a wireless manner to achieve various communication functions. A conventional machine to machine (M2M) SIM is available for a car industry, a medical electronic industry, a wisdom electric meter or the like. In practice, the information of the user and the telecommunication operator is burned previously in the conventional M2M SIM to provide a wireless communication connection, so that the user can control the information of various electronic equipments. However, the M2M SIM is previously provided in the circuit board of an electronic equipment during the production process. In addition, the M2M SIM has a closed design so that the user cannot know where the M2M SIM is located. Further, the M2M

SIM is not provided with a SIM card slot so that the user cannot use a SIM card to proceed a wireless communication connection. Further, when the M2M SIM is inoperative or fails, it takes a long time to repair the M2M SIM, and there is no other wireless communication connection to replace the M2M SIM, so that the user has not choice but to wait, thereby causing inconvenience to the user.

### BRIEF SUMMARY OF THE INVENTION

In accordance with the present invention, there is provided a interface card, comprising a circuit board having a terminal provided with an interface unit, a communication operation processing unit mounted on the circuit board, a subscriber identity module (SIM) card slot mounted on the circuit board, and a machine to machine (M2M) SIM mounted on the circuit board. The interface unit of the circuit board is coupled with an interface card slot of an external electronic equipment to provide at least one signal output or input. The communication operation processing unit provides at least one signal input or output to perform integration, operation and processing of various information. The SIM card slot allows insertion of a SIM card and outputs at least one signal to the communication operation processing unit. The M2M SIM is provided with a communication protocol of a predetermined telecommunication operator and outputs at least one signal to the communication operation processing unit.

Preferably, the circuit board has a circuit layout which is connected respectively with the communication operation processing unit, the SIM card slot, the M2M SIM, and the interface unit.

Preferably, the interface unit of the circuit board has a specification of Mini PCI-E and is compatible with the electronic equipment.

Preferably, the interface card further comprises an audio interface unit mounted on the circuit board. The audio interface unit has a socket to allow insertion of a plug of an external earphone so as to provide an audio communication function.

Preferably, the SIM card slot of the interface card has a specification that can receive a mini SIM card with a size of 25 mm*15 mm.

Preferably, the SIM card slot of the interface card has a specification that can receive a micro SIM card with a size of 15 mm*12 mm.

Preferably, the SIM card slot of the interface card has a specification that can receive a nano SIM card with a size of 8.8 mm* 12.3 mm.

The primary objective of the present invention is to provide an interface card with multiple subscriber identity modules (SIM).

According to the primary advantage of the present invention, the interface card has a SIM card slot and a M2M SIM to provide two wireless communication connection modes for selection of a user, so that the user can select any one of the wireless communication connection modes according the practical requirement, without being restricted by the hardware of the electronic equipment, thereby greatly enhancing the versatility of the interface card.

According to another advantage of the present invention, the interface card is additionally provided with the audio interface unit, so that after an external earphone is connected with the audio interface unit, the interface card can provide a telephone communication function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a schematic top view of an interface card in accordance with the preferred embodiment of the present invention.

FIG. 2 is a schematic top view showing the interface card being connected with a SIM card and an external electronic equipment.

FIG. 3 is a flow chart showing a wireless communication connection of the interface card as shown in FIG. 1.

### DETAILED DESCRIPTION OF THE INVENTION

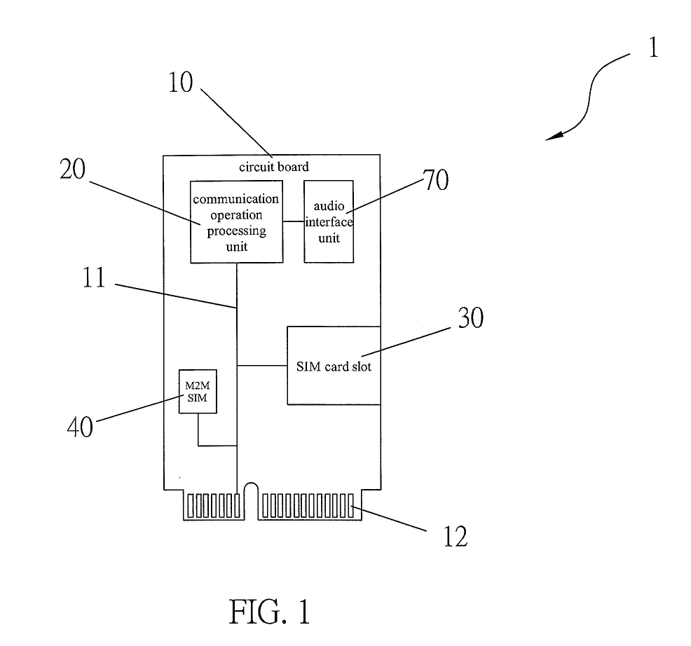

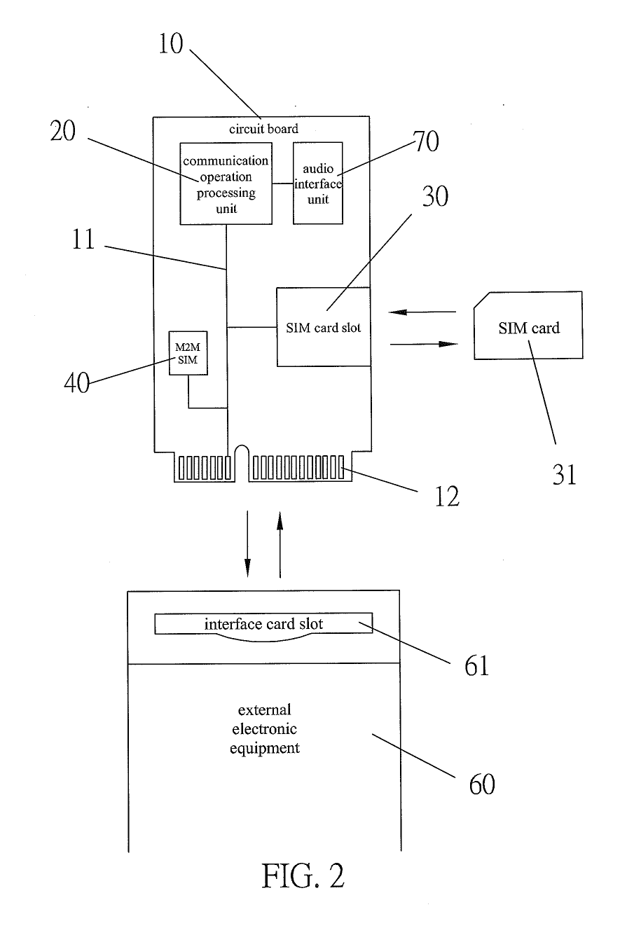

Referring to the drawings and initially to FIGS. 1 and 2, an interface card 1 in accordance with the preferred embodiment of the present invention comprises a circuit board 10 having a terminal provided with an interface unit 12, a communication operation processing unit 20 mounted on the circuit board 10, a subscriber identity module (SIM) card slot 30 mounted on the circuit board 10, a machine to machine (M2M) SIM 40 mounted on the circuit board 10, and an audio interface unit 70 mounted on the circuit board 10.

The circuit board 10 has a circuit layout 11 which is connected respectively with the communication operation processing unit 20, the SIM card slot 30, the M2M SIM 40, and the interface unit 12. The interface unit 12 of the circuit board 10 is coupled with an interface card slot 61 of an external electronic equipment 60 (such as a cell phone, notebook computer, i-pad or other wireless communication device) to provide at least one signal output or input. In the preferred embodiment of the present invention, the interface unit 12 of the circuit board 10 has a specification of Mini PCI-E and is compatible with the electronic equipment 60.

The communication operation processing unit 20 provides at least one signal input or output to perform integration, operation and processing of various information.

The SIM card slot 30 allows insertion of a SIM card 31 and outputs at least one signal to the interface unit 12 of the circuit board 10 and the communication operation processing unit 20.

In the preferred embodiment of the present invention, the SIM card slot 30 of the interface card 1 has a specification that can receive a mini SIM card with a size of 25 mm*15 mm, a micro SIM card with a size of 15 mm*12 mm, or a nano SIM card with a size of 8.8 mm*12.3 mm.

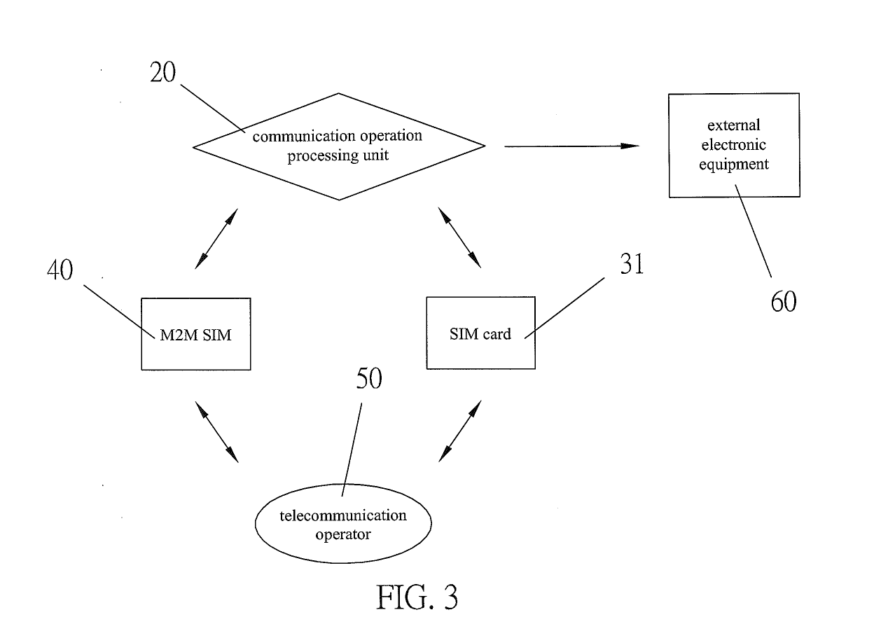

The M2M SIM 40 is provided with a communication protocol of a predetermined telecommunication operator 50 (see FIG. 3) and outputs at least one signal to the interface unit 12 of the circuit board 10 and the communication operation processing unit 20.

In operation, referring to FIG. 3 with reference to FIGS. 1 and 2, the interface card 1 of the present invention comprises a SIM card slot 30 and a M2M SIM 40 to provide two wireless communication connection modes for selection of a user.

When the user selects the first mode of the SIM card slot 30, the SIM card 31 is inserted into the SIM card slot 30 of the interface card 1. In such a manner, the SIM card slot 30 of the interface card 1 is connected with the telecommunication operator 50 through the SIM card 31, so that the information in the SIM card 31 proceeds an information transmission with the telecommunication operator 50, and returns at least one message to the communication operation processing unit 20 through the SIM card slot 30 of the interface card 1. Then, the communication operation processing unit 20 of the interface card 1 integrates, operates and processes the message, and transmits a signal through the interface unit 12 of the circuit board 10 to the electronic equipment 60, so that the electronic equipment 60 can proceed a wireless communication connection.

Alternatively, when the user selects the second mode of the M2M SIM 40, the information of the telecommunication operator 50 is burned previously to the M2M SIM 40. In such a manner, the M2M SIM 40 is connected with the information of the telecommunication operator 50, and returns at least one message to the communication operation processing unit 20. Then, the communication operation processing unit 20 of the interface card 1 integrates, operates and processes the message, and transmits a signal through the interface unit 12 of the circuit board 10 to the electronic equipment 60, so that the electronic equipment 60 can proceed a wireless communication connection.

Again referring to FIGS. 1 and 2, the audio interface unit 70 is connected with the communication operation processing unit 20. The audio interface unit 70 has a socket to allow insertion of a plug of an external earphone so as to provide an audio communication function. The audio interface unit 70 includes two audio connection modes. In practice, the audio interface unit 70 connects the electronic equipment 60 through the communication operation processing unit 20 and the interface unit 12 of the circuit board 10 so as to proceed an audio communication. Alternatively, the audio interface unit 70 directly connects the electronic equipment 60 through the communication operation processing unit 20 so as to proceed an audio communication without having to use the interface unit 12 of the circuit board 10 so as to avoid a too long line and an interference.

Accordingly, the interface card 1 has a SIM card slot 30 and a M2M SIM 40 to provide two wireless communication connection modes for selection of a user, so that the user can select any one of the wireless communication connection modes according the practical requirement, without being restricted by the hardware of the electronic equipment 60, thereby greatly enhancing the versatility of the interface card 1. In addition, the interface card 1 is additionally provided with the audio interface unit 70, so that after an external earphone is connected with the audio interface unit 70, the interface card 1 can provide a telephone communication function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An interface card, comprising:
a circuit board having a terminal provided with an interface unit;
a communication operation processing unit mounted on the circuit board;
a subscriber identity module (SIM) card slot mounted on the circuit board; and
a machine to machine (M2M) SIM mounted on the circuit board;
wherein:
the interface unit of the circuit board is coupled with an interface card slot of an external electronic equipment to provide at least one signal output or input;
the communication operation processing unit provides at least one signal input or output to perform integration, operation and processing of various information;
the SIM card slot allows insertion of a SIM card and outputs at least one signal to the communication operation processing unit; and
the M2M SIM is provided with a communication protocol of a predetermined telecommunication operator and outputs at least one signal to the communication operation processing unit.

2. The interface card of claim 1, wherein the circuit board has a circuit layout which is connected respectively with the communication operation processing unit, the SIM card slot, the M2M SIM, and the interface unit.

3. The interface card of claim 1, wherein the interface unit of the circuit board has a specification of Mini PCI-E and is compatible with the electronic equipment.

4. The interface card of claim 1, wherein:
the interface card further comprises an audio interface unit mounted on the circuit board; and
the audio interface unit has a socket to allow insertion of a plug of an external earphone so as to provide an audio communication function.

5. The interface card of claim 1, wherein the SIM card slot of the interface card has a specification that can receive a mini SIM card with a size of 25 mm*15 mm.

6. The interface card of claim 1, wherein the SIM card slot of the interface card has a specification that can receive a micro SIM card with a size of 15 mm*12 mm.

7. The interface card of claim 1, wherein the SIM card slot of the interface card has a specification that can receive a nano SIM card with a size of 8.8 mm*12.3 mm.
